(19) United States
(12) Patent Application Publication
(10) Pub. No.: US 2007/0233361 A1
(43) Pub. Date: Oct. 4, 2007

(54) Centralized Image Processing For An Automobile With A Navigation System

(75) Inventors: Aric Shaffer, Ypsilanti, MI (US); Ronald Miller, Saline, MI (US); Dan Raceu, Warren, MI (US); Gurpreet Aulakh, Brownstown Twp., MI (US); Anya Getman, Belleville, MI (US); David DiMeo, Windsor (CA)

Correspondence Address: Dickinson Wright PLLC, 38525 Woodward Avenue, Suite 2000, Bloomfield Hills, MI, 48304, US

(73) Assignee: Ford Global Technologies, LLC, Dearborn, MI (US)

(21) Appl. No.: 11/277,972

(22) Filed: Mar. 30, 2006

(51) Int. Cl. G01C 21/00

(52) U.S. Cl. 701/200

(57) ABSTRACT

A vehicle system 10 includes various cameras 36 that generate camera output signals. A navigation system 12 is included within the vehicle. The navigation system includes an image processor and receives the output signals from the cameras 36. The image processor 18 creates output signals suitable for display on display 16 of the navigation system 12.

### TECHNICAL FIELD

The present invention relates generally to navigation systems, and more particularly, to a navigation system that processes images from various cameras throughout the vehicle.

### BACKGROUND

Various technologies for accident avoidance in pre-deployment conditions have been proposed. Such systems typically include a camera or plurality of cameras that monitor various positions. The cameras typically process the outputs and provide a display type signal to a display within the vehicle.

Another feature that is common in vehicles is a navigation system. Currently, navigation systems are about a $2000 option and are rarely used for daily driving.

It would therefore be desirable to provide image processing within a navigation system so that various systems may be integrated together and displayed on the navigation system. This will lower the cost of the navigation system combined with the various other systems of the vehicle.

### SUMMARY

In one aspect of the invention, a system comprises a plurality of cameras generating a respective plurality of output signals and a navigation system. The navigation system includes a display and image processing. The image processing processes the camera output signals into video signals that are displayed on the display.

One feature of the invention is that power line communications or RF communications may be used to link the camera output signals to the navigation system. By using power line communication or RF communication, additional processing burden in the vehicle is reduced or minimized. This will allow the rapid implementation of such a system and reduce the overall cost of the vehicle with such features.

In a further aspect of the invention, a method for operating a system includes generating a plurality of camera output signals, processing the camera output signals in a navigation system to form video signals, and coupling the video signals to a display.

Other advantages and features of the present invention will become apparent when viewed in light of the detailed description of the preferred embodiment when taken in conjunction with the attached drawings and appended claims.

### BRIEF DESCRIPTION OF THE DRAWINGS

FIG. 1 is a block diagrammatic view of a system according to the present invention.

FIG. 2 is a front view of a display formed according to the present invention.

FIG. 3 is a flow chart illustrating a process of one embodiment according to the present invention.

### DETAILED DESCRIPTION OF THE PREFERRED EMBODIMENT

In the following figures the same reference numerals will be used to identify the same components.

In the following figures a specific embodiment using five different cameras is set forth. However, those skilled in the art will recognize various numbers of cameras may be implemented on such a system. For example, one type of system may include only three cameras, one for each side, and one for the rear view. Other embodiments will be evident to those skilled in the art.

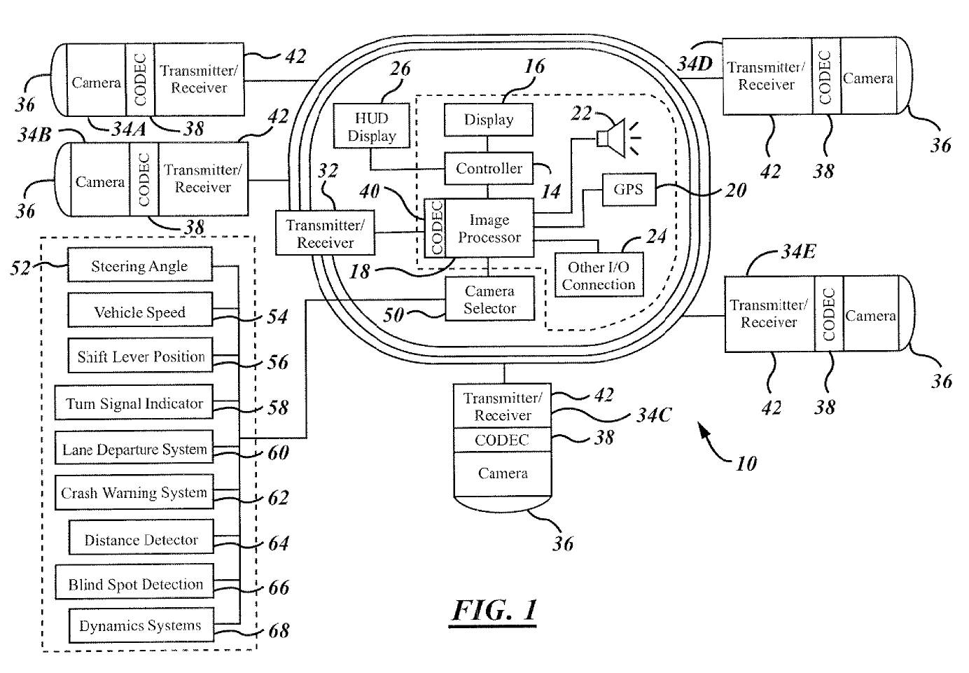

Referring now FIG. 1, a vehicle system 10 is illustrated having a navigation system 12. The navigation system 12 includes various features such as a controller 14, a display 16, an image processor 18, a global positioning system 20, an audible output such as a speaker 22, and another I/O connection 24 for connecting to various other devices. The controller 14 may also be coupled to a heads up display 26. The controller 14 performs various navigation functions such as displaying the position of the vehicle relative to a map on display 16 or heads up display 26. In image processor 18 is used to control the display 16 to display the position of the vehicle and the map associated therewith.

The vehicle 10 includes a network 30 that is used to communicate various information throughout the vehicle. A transmitter/receiver 32 coupled to image processor 18 may be used to receive and transmit information from the network 30. For example, the transmitter/receiver 32 may receive camera signals from cameras 34A, 34B, 34C, 34D, and 34E. Camera 34A is a front left side camera. 34B is a rear left side camera. Camera 34C is a rear camera. Camera 34D is front right side camera, and camera 34E is a rear left side camera. Cameras 34A and 34D may be completely front facing or front and side facing depending on the various types of lenses associated therewith. Also, cameras 34B and 34E may be completely eliminated if the field of view of the camera is increased using a prism or wide view lens 36. Of course, a wide view lens may be implemented on various cameras even if five cameras are used. Also, those skilled in the art will recognize that more cameras, or various numbers of cameras, may be used based upon the specific implementation. These are in part dictated by the vehicle design and the desired functionality of the system.

Each camera 34 may include a compression/decompression algorithm (CODEC) 38. The CODEC 38 will allow the information to be more easily transmitted to the image processor 18 through the transmitter/receiver 32. A CODEC 40 may also be included in the image processor 18 for decompressing the signals from the camera. The CODEC 38 associated with each camera is mainly used for compressing the signals for transmission.

A transmitter/receiver 42 is also associated with each camera. The transmitter/receiver 42 is used for transmitting the camera output signals to the transmitter/receiver 32. The transmitter/receiver 34D may include power line communications or RF communications. A combined transceiver may replace transmitter/receiver 32. That is, in one embodiment the camera output signals may be superimposed upon the signals within the network so that they may be easily removed therefrom. This is called power line coding. Power line coding in general is known in the art. However, this specific application is unknown by the authors. The lines associated in the drawings of FIG. 1 may also represent a wireless connection. That is, a wireless RF connection may be used from transmitter/receiver 42 to transmitter/receiver 32. Both an RF connection, an RF wireless connection, or a power line carrier connection have the advantage that the system may be superimposed upon existing vehicle systems without interference and without utilizing valuable resources on the network.

A camera selector 50 may also be associated with the system. A camera selector 50 will select the appropriate cameras based upon the conditions so that image processing is only performed on the desired camera output signals. Of course, the image processor 18 may process all of the cameras but such processing may be unnecessary. The camera selector 50 may be coupled to various sensors or systems such as a steering angle sensor 52, a vehicle speed sensor 54, a shift lever position 56, a turn signal indicator 58, a lane departure system 60, a crash warning system 62, and a distance detector 64.

The steering angle sensor 52 may comprise a sensor coupled within the steering column to set forth a steering angle of the vehicle wheels themselves or of the hand wheel. Typically the steering angle sensor 52 may generate an output corresponding to the hand wheel of the vehicle. By knowing the gearing ratio of the steering system, the steering angle of the steered wheels may also be determined.

Vehicle speed sensor 54 may be one of various types of vehicle speed sensors or algorithms including toothed-wheel-type sensors typically found in anti-lock braking systems. Other types of suitable sensors include transmission sensors and the like.

Turn signal indicator 58 may be a turn signal light or a stalk position.

Lane departure system 60 may be one of various types of lane departure systems that detect the vehicle is moving from the particular lane. Cameras in the direction of movement may thus be used by the system.

The crash warning system 62 may include various types of warning systems including a radar system, lidar system, camera-based system, or combinations of the systems.

A blind spot detection system 66 may also be used. The blind spot detection system 66 may also include various cameras. Other systems including cameras may include the lane departure system 60, the crash warning system 62, and the distance detector 64. Thus, these systems may already be a part of the vehicle.

The I/O connection 24 may include various types of inputs including push buttons or keypads, and the like. The system may also include a touch screen display.

The camera selector 50 may also be coupled to dynamic system 68, including but not limited to anti-lock brakes, traction control, yaw stability control and roll stability control systems. Such systems may use other types of sensors such as yaw rate sensors, roll rate sensors, pitch rate sensors, lateral accelerometers, longitudinal accelerometers, vertical accelerometers, and the like to determine the direction and heading of the vehicle. These signals may provide the camera selector 50.

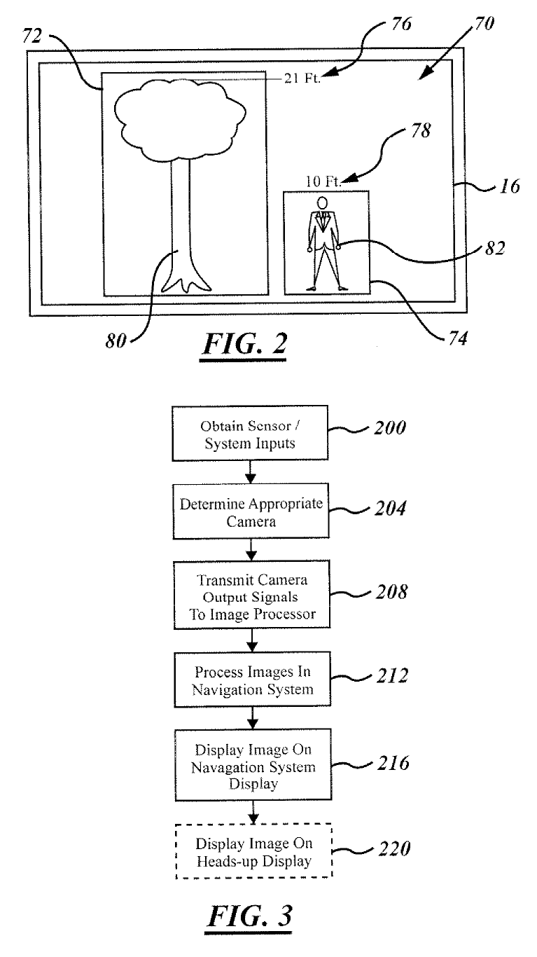

Referring now to FIG. 2, an example of a possible display 16 is illustrated. Display output 70 may include box-type indicia 72, 74. The box-type indicia 74 may have a numerical indicator 76, 78 associated therewith. For example, box 72 corresponds to a tree 80, which has a distance of 21 feet from the vehicle. Box 74 corresponds to a pedestrian 82 that has a distance 78 of 10 feet. Of course, the display will be continually updated so that the vehicle operator is constantly updated with the condition around the vehicle.

Referring now to FIG. 3, a method for operating the system is set forth. In step 200, the various sensor/system inputs are obtained. The sensors may include the various inputs set forth as reference numerals 52-68. Of course, those skilled in the art may recognize that various other inputs may be provided. In step 204, the appropriate camera is selected in response to the various inputs. A lookup table or various thresholds may be set forth for the appropriate camera. For example, when the vehicle is determined to go right or potentially right such as by the turn signal indicator or the lane departure system, the cameras on the right side of the vehicle may be used. Likewise, when the vehicle is in reverse as indicated by the shift lever position, the rear and potentially right and left side cameras may also be used. Portions of the cameras may be used on the display. The camera outputs may be displayed separately or combined in a single image.

In step 208, the camera outputs from the appropriate cameras selected by the camera selector 50 are transmitted to the image processor. In step 212, the images are processed in the navigation system. Of course, those skilled in the art will also recognize that the camera selector 50 may be part of or separate from the navigation system. The images are processed to form display images. In step 216, the images are displayed on the navigation system. As mentioned above, the navigation system may display the output of several cameras separately along with appropriate indications as to a distance to the object. Audible warnings and the like may also be generated to warn the vehicle operator as to the distance of various objects. The images may be displayed separately or together to form one single image. In step 220, the images may be displayed on the heads up display as an optional step. The heads up display may be simultaneously displayed with the navigation system display or may be separately displayed. The heads up display may also contain various other information such as speed information, turn signal indicators and the like.

While particular embodiments of the invention have been shown and described, numerous variations and alternate embodiments will occur to those skilled in the art. Accordingly, it is intended that the invention be limited only in terms of the appended claims.

What is claimed is:

1. A vehicle system comprising:
a camera generating a respective camera output signal; and
a navigation system comprising a display and image processing, said image processing the camera output signal into video signals that are displayed on the display.

2. A vehicle system as recited in claim 1 wherein the camera is coupled to the transmitter using power line communication.

3. A vehicle system as recited in claim 1 wherein the camera is coupled to the transmitter using RF communication.

4. A vehicle system as recited in claim 1 wherein the camera is coupled to the transmitter using wireless RF communication.

5. A vehicle system as recited in claim 1 wherein the display is coupled to the image processor using power line communication.

6. A vehicle system as recited in claim 1 wherein the display is coupled to the image processor using RF communication.

7. A vehicle system as recited in claim 1 wherein the display is coupled to the image processor using wireless RF communication.

8. A vehicle system as recited in claim 1 further comprising a heads up display coupled to the image processor.

9. A vehicle system as recited in claim 1 wherein the camera comprises a plurality of cameras and further comprising a plurality of system inputs and a camera selector selecting a camera or cameras from the plurality of cameras for the image processor to process.

10. A vehicle system as recited in claim 9 wherein the plurality of cameras comprises three cameras.

11. A vehicle system as recited in claim 10 wherein the three cameras comprise a right side camera, a left side camera and a rear camera.

12. A method comprising:
generating a plurality of camera output signals;
processing the camera output signals in a navigation system to form video signals; and
coupling the video signals to a display.

13. A method as recited in claim 12 wherein each of the plurality of cameras is coupled to the transmitter using power line communication.

14. A method as recited in claim 12 wherein each of the plurality of cameras is coupled to the transmitter using RF communication.

15. A method as recited in claim 12 wherein each of the plurality of cameras is coupled to the transmitter using wireless RF communication.

16. A method as recited in claim 12 wherein the display comprises a heads-up display.

17. A method as recited in claim 12 further comprising generating a plurality of vehicle system outputs and selecting one or more of the plurality of cameras in response to the vehicle system outputs.

18. A method as recited in claim 12 wherein the plurality of cameras comprises three cameras.

19. A method as recited in claim 12 wherein the three cameras comprise a right side camera, a left side camera and a rear camera.
